(19) United States
(12) Patent Application Publication
(10) Pub. No.: US 2016/0074135 A1
(43) Pub. Date: Mar. 17, 2016

(54) ADJUSTABLE DENTAL HAND INSTRUMENT

(71) Applicant: UMM Al-Qura University, Makkah (SA)

(72) Inventors: Khalid Talal Abduallah ABOALSHAMAT, Kelvin Grove (AU); Atif KHOJAH, Boston, MA (US)

(73) Assignee: UMM Al-Qura University, Makkah (SA)

(21) Appl. No.: 14/388,623

(22) PCT Filed: Sep. 12, 2014
(86) PCT No.: PCT/IB2014/001819

§ 371 Date: Sep. 26, 2014

(51) Int. Cl. A61C 1/14

(52) U.S. Cl. CPC A61C 1/141

(57) ABSTRACT

A dental instrument and a dental kit comprising multiple dental instruments are disclosed for use in dental examination, extraction and reconstruction procedures. Each dental instrument is composed of three detachable components: the handle, the arm and the head. These components are connected to one another during assembly through magnetized hexagonal projections and hollows of 0.5-1.0 cm in length or depth to provide fast and sturdy connections between the components. Multiple versions of the arm and the head are provided to enable different angulations, different combinations of angulations, different configurations and sizes of a single type of dental instrument, different types of dental instruments to be assembled during the dental treatment procedure. Embodiments disclosed herein help to create a neat and orderly working environment for the dental professional wherein the multiple tools required for a procedure are provided in a compact kit.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Dental instruments are tools that dental professionals use to provide dental treatment to their patients. Dental professionals including dentists, hygienists and dental assistants use various types of instruments to examine, manipulate, clean, restore (reconstruct) and remove teeth and surround oral structures.

Some dental instruments are referred to by their use while others are referred to by their technical name. There can be three basic groups of dental instruments used in general dentistry: 1) General instruments that are used to in a variety of procedures; 2) Extraction instruments; and 3) Instruments used for reconstruction of the teeth.

Examples of the general instruments include but are not limited to the explorer, mirror, scalar and curette. The explorer has a variety of uses. It can be used to prod the teeth in order to check for soft spots that indicate the presence of cavities, to scrape plaque or tartar off the surfaces of teeth or to help with the placement of amalgam during the filling process. The dental explorer is sometimes called a “sickle probe” due to its shape wherein a sharp point is disposed at the end of the instrument to enhance tactile sensation. There are various types of explorers, though the most common one is the No. 23 explorer, which is also known as a “shepherd's hook”. Other types include the 3CH (also known as “cowhorn” or “pigtail”) and No. 17 explorers, which are useful for the interproximal areas between teeth. There is the Tufts 17/23 Explorer, also known as the Wilken's Explorer that contains both No. 17 and No. 23 on the same instrument and at opposite sides of each other.

The dental mirror aids the dental professional with a better view of the working area, especially indirect vision in certain locations of the mouth where visibility is difficult or impossible. The posterior surface of the anterior maxillary teeth is a good example of an area where mirrors are often used. Other areas of the mouth can be viewed more readily with the dental mirror, even though it would be possible to see them if the dental professional adjusted his or her body into a poor position. Additionally, the mirror can also be used to suppress the tongue or retract the cheeks, keeping them away from the hand piece in the drilling process. The head of the dental mirror is usually round, and the most common sizes used are the No. 4 and No. 5. A No. 2 is sometimes used when a smaller mirror is needed, such as when working on back teeth with a dental dam in place.

The scalar is primarily used in the prophylactic and periodontal care of teeth, including scaling and root planning. It is used to scrape solidified plaque and tartar off the surfaces of the teeth both above and below the gum line. Occasionally, the scalar is used to scrape off excessive glue from crowns or sealant material from the application of sealants. The working ends of a scalar come in a variety of shapes and sizes, but they are always narrow at the tip, so as to allow for access to narrow embrasure spaces between teeth. Scalers are best used when their terminal shanks, namely the last portions of the handle attached to the blades, are held parallel to the long axis of the tooth. Scalers can be further divided into the anterior scaler and the posterior scaler. The anterior scaler has a straight terminal shank while the posterior scaler has an angled terminal shank to allow for easy access to the surfaces of posterior teeth.

Periodontal curettes serve similar functions as scalars except that they are always rounded at the tip in order to make subgingival cleansing less traumatic to the gingiva. Types of curettes include the universal curettes that have a semicircular tip used at 90° to the tooth root surface and Gracey curettes that are semicircle tipped, but have one edge lower than the other, used at 70° to the tooth root surface.

The second category of dental instruments, namely the extraction or surgical instruments, allow the dental professional to extract teeth from the mouth of the patient. Examples of dental extraction instruments include the elevator and forceps. During the extraction process, elevators arc used to pry back the gum tissue and dig underneath the tooth in order to thrust the tooth upward for extraction. Elevators come in small, medium and large sizes. Varieties of forceps include the upper anterior, lower anterior, upper posterior, and lower posterior forceps. Each of these particular forceps also comes in pediatric sizes.

Reconstruction of the teeth is done in many different ways and for numerous different reasons. Dental reconstruction includes amalgam and composite fillings, bonding, shaping, crowning, and root removal of the teeth. Examples of dental reconstruction instruments include the handpiece or the drill, excavator, burnisher, plugger, spatula and carver. Each of these instruments comes in various sizes, shapes and angulations too. In general, reconstruction instruments are used to either condense, smooth and polish amalgam and composite, to create anatomy, to carry and place restorative material for cavity preparation or to trim and remove excess filling materials.

In view of the foregoing paragraphs, it can be appreciated immediately by an artisan of ordinary skill in the art that dental professionals can sometimes rely on a large number of dental instruments to perform a single dental procedure. Many of these dental instruments are very similar with minor differences in size and angulation to be used for right or left positions and on different tooth locations. Like any medical procedure, precision, speed and timing are crucial in a dental procedure. The large number of dental instruments crowding on a dental professional's operating table hinders the procedure and may even increase the risk of an accident. These dental instruments have to be sterilized by autoclave each time they are used, even if the use may be minimal, therefore reducing the durability of the instruments.

Accordingly, a need exists for dental instruments or a dental kit that can create a neat working environment for dental professionals, reduce their burden of having to purchase multiple instruments and having to sterilize them after every use, as well as prolonging the durability of these dental instruments.

### BRIEF SUMMARY OF THE INVENTION

The foregoing paragraphs have been provided by way of general introduction, and are not intended to limit the scope of the following claims. The described embodiments, together with further advantages, will be best understood by reference to the following detailed description taken in conjunction with the accompanying drawings.

According to a first broad aspect, the present disclosure relates to a dental instrument comprising an elongated handle having a hexagonal opening disposed at one end of the handle along a longitudinal axis of a main body of the handle, wherein the hexagonal opening is magnetized, an arm including a main body portion, the arm including a magnetized hexagonal projection disposed at a first end of the arm, and a magnetized hexagonal opening disposed at a second end of the arm and a head including a main body of a working tip and a magnetized hexagonal projection extending from the working tip. The magnetized hexagonal projection of the head is configured to be inserted into the magnetized hexagonal opening of the arm, and the magnetized hexagonal projection of the arm is configured to be inserted into the magnetized hexagonal opening of the handle.

According to a second broad aspect, the present disclosure relates to a kit comprising a plurality of handles, each of the plurality of handles is an elongated, axial piece that includes a first magnetized hexagonal hollow disposed at one end of the piece along the axial axis, a plurality of heads that each include a working tip and a first magnetized hexagonal projection and a plurality of arms that each include a main body portion, a second magnetized hexagonal projection disposed at a first end of the arm, and a second magnetized hexagonal hollow disposed at a second end of the arm. The first magnetized hexagonal projection of the head is inserted into the second magnetized hexagonal hollow of the arm and the second magnetized hexagonal projection of the arm is inserted into the first magnetized hexagonal hollow of the handle. Any one of the plurality of handles is configured to be engaged with any one of the plurality of arms, and any one of the plurality of arms is configured to be engaged with any one of the plurality of heads, such that a handle, an arm and a head are detachably attached to each other.

Exemplary implementations of the present disclosure include:

A: A dental instrument, comprising:

an elongated handle having a hexagonal opening disposed at one end of the handle along a longitudinal axis of a main body of the handle, wherein the hexagonal opening is magnetized;

an arm including a main body portion, the arm including a magnetized hexagonal projection disposed at a first end of the arm, and a magnetized hexagonal opening disposed at a second end of the arm; and

a head including a main body of a working tip and a magnetized hexagonal projection extending from the working tip,

wherein the magnetized hexagonal projection of the head is configured to be inserted into the magnetized hexagonal opening of the arm, and the magnetized hexagonal projection of the arm is configured to be inserted into the magnetized hexagonal opening of the handle.

B: The dental instrument of A, wherein each of the handle, the arm and the head are detachably assembled to each other at different angles with respect to each other.

C: The dental instrument of B, wherein after each of the handle, the arm and the head are detachably assembled to each other, a longitudinal axis of the main body portion of the arm is oriented at an angle with respect to the longitudinal axis of the handle, and a longitudinal axis of the head is oriented at an angle with respect to the longitudinal axis of the main body of the arm.

D: The dental instrument of C, wherein the angle between the longitudinal axis of the handle and the main body portion of the arm is 90°-180°.

E: The dental instrument of C, wherein the angle between the head and the main body portion of the arm is 45°-180°.

F: The dental instrument of A, wherein the magnetized hexagonal projections and magnetized hexagonal hollows are 0.5-1.5 cm.

G: The dental instrument of A, wherein the arm further comprises a first connecting portion between the main body portion and the second magnetized hexagonal hollow and a second connecting portion between the main body portion and the second magnetized hexagonal projection.

H: The dental instrument of A, wherein the head further comprises a third connecting portion.

I: The dental instrument of A, wherein the handle further comprises a plurality of serrations on the outer surface.

J: The dental instrument of A, wherein the handle further comprises a rubber, silicone or polymeric layer.

K: The dental instrument of A, wherein the handle is a cylinder with a circular base.

L: The dental instrument of A, wherein the handle is a prism with hexagonal base.

M: A kit, comprising:

a plurality of handles, each of the plurality of handles is an elongated, axial piece that includes a first magnetized hexagonal hollow disposed at one end of the piece along the axial axis;

a plurality of heads that each include a working tip and a first magnetized hexagonal projection; and

a plurality of arms that each include a main body portion, a second magnetized hexagonal projection disposed at a first end of the arm, and a second magnetized hexagonal hollow disposed at a second end of the arm,

wherein the first magnetized hexagonal projection of the head is inserted into the second magnetized hexagonal hollow of the arm and the second magnetized hexagonal projection of the arm is inserted into the first magnetized hexagonal hollow of the handle, and

wherein any one of the plurality of handles is configured to be engaged with any one of the plurality of arms, and any one of the plurality of arms is configured to be engaged with any one of the plurality of heads, such that a handle, an arm and a head are detachably attached to each other.

N: The kit according to M, wherein after each of the handle, the arm and the head are detachably assembled to each other, a longitudinal axis of the main body portion of the arm is oriented at an angle with respect to the longitudinal axis of the handle, and a longitudinal axis of the head is oriented at an angle with respect to the longitudinal axis of the main body of the arm.

O: The kit according to N, wherein the handle, arm and head can be assembled at different angles and different combinations of angles for creating different dental instruments for different dental procedures.

P: The kit of O, wherein the angle between the longitudinal axis of the handle and the main body portion of the arm is 90°-180°.

Q: The kit of N, wherein the angle between the head and the main body portion of the arm is 45°-180°.

R: The kit of M, wherein the magnetized hexagonal projections and magnetized hexagonal hollows are 0.5-1.5 cm.

S: The kit of M, wherein the arm further comprises a first connecting portion between the main body portion and the second magnetized hexagonal hollow and a second connecting portion between the main body portion and the second magnetized hexagonal projection.

T: The kit of M, wherein the head further comprises a third connecting portion.

U: The kit of M, wherein the handle further comprises a plurality of serrations on the outer surface.

V: The kit of M, wherein the handle further comprises a rubber, silicone or polymeric layer.

W: The kit of M, wherein the handle is a cylinder with a circular base.

X: The kit of M, wherein the handle is a prism with hexagonal base.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a dental kit consisting of head, arm and handle components of different configurations according to an exemplary embodiment.

FIG. 2a shows a head, an arm and a handle from the dental kit of FIG. 1 that can be assembled together to form a curette according to an exemplary embodiment.

FIG. 2b is an exploded view of the curette of FIG. 2a according to an exemplary embodiment.

FIG. 3 is an exploded view showing how a head, an arm and a handle can be assembled according to an exemplary embodiment.

### DETAILED DESCRIPTION OF THE EMBODIMENTS

Referring now to the drawings, wherein like reference numerals designate identical or corresponding parts throughout the several views.

Dental professionals like dentists, dental hygienists and dental assistants depend upon many different instruments to perform dental work. These instruments include but are not limited hand instruments that are used for cavities removal, adjusting the filling cavity, and placing the filling. These hand instruments are different from those used for ultrasonic or machine rotary instruments. As a result, dental professionals can sometimes use a large number of instruments to conduct a single dental procedure each time. Some of these instruments are barely used in the mouth for testing size compatibility to the procedure to be done. Sometimes, multiple similar instruments are found as different sizes or different angulation to be used for right or left positions, or to be used in inaccessible areas. This increases the burden of having to buy different sizes and angulations for the same instruments.

Moreover, dental instruments need to be sterilized after every use regardless of how minimal the use may be. Repeated autoclaving leads to wear and tear that reduces the life of the instruments.

In one embodiment, the present disclosure aims to ease and enhance the work of dental professionals by providing a compact dental kit which is composed of primarily three detachable components that can be assembled together into a single dental instrument with one or more specific functions. These components are namely the handle, the arm and the head. The handle is the part that a dental professional holds and or grips. The arm connects the head to the handle. The head is the active part performing the operation of the dental instrument and comes in direct contact with teeth and other parts of the mouth cavity during a dental procedure.

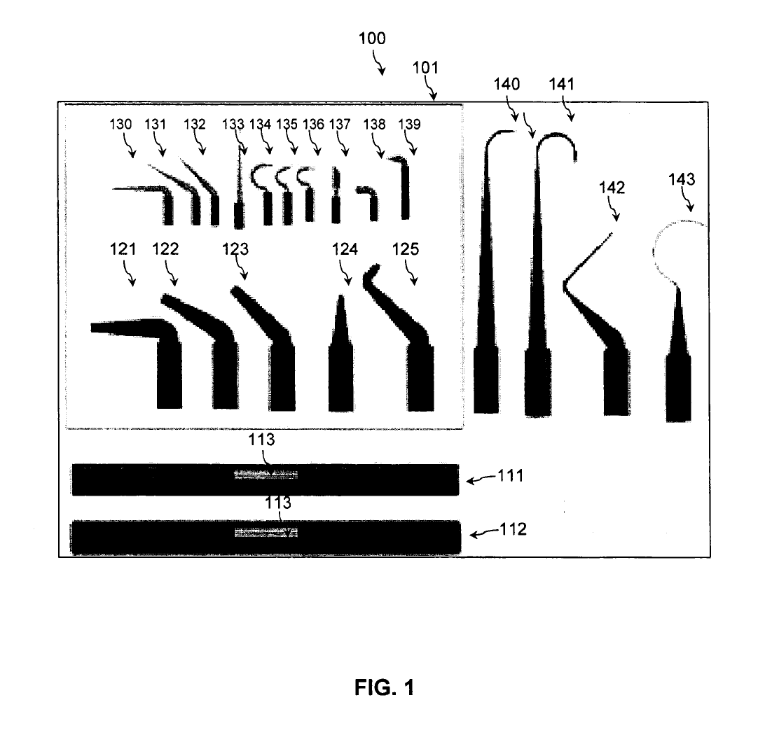

Each of the three components (head, handle, arm) comes in a variety of configurations and angulations within the same kit. FIG. 1 shows an exemplary embodiment of a dental kit 100. In some embodiments, the dental kit may be contained in a housing or a box 101, that is no larger than 30 cm×30 cm. In one embodiment, the box 101 may be 25 cm×20 cm. Constructive materials for the housing or the box include metal, stainless steel, wood and plastic (polymers). In some embodiments, the housing or the box may further include compartments within so that each detachable component may be arranged and placed next to one another with sufficient space between them.

In some embodiments, the head, handle and arm components may be made of stainless steel. In some embodiments, these components may be of plastic if disposable kits are desired.

Still referring to FIG. 1, multi-component dental kit 100 may be equipped with a set of handles (111, 112), a set of arms (121, 122, 123, 124, 125) and a set of heads (130, 131, 132, 133, 134, 135, 136, 137, 138, 139, 140, 141, 142, 143). Heads 130-143 may include explorers, mirrors, scalars, curettes, elevators, excavators, burnishers, pluggers, spatulas and carvers in different configurations (not all are shown in FIG. 1).

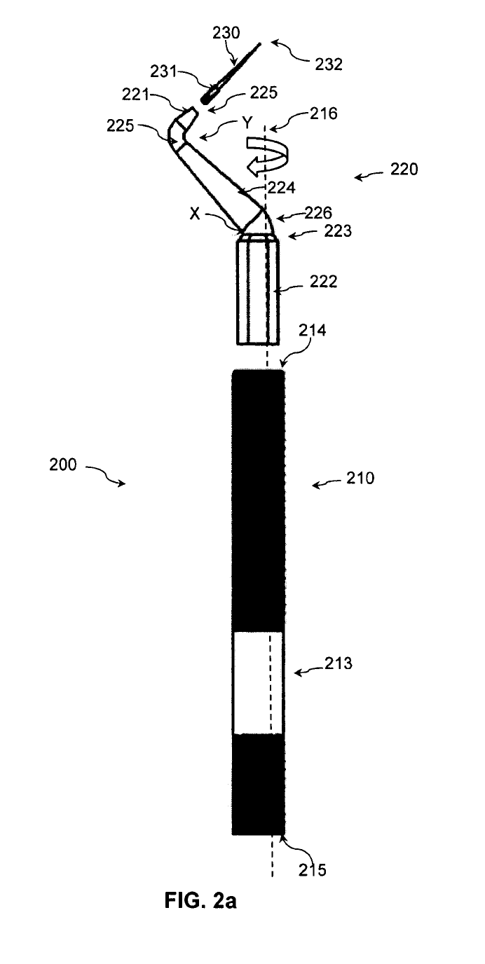

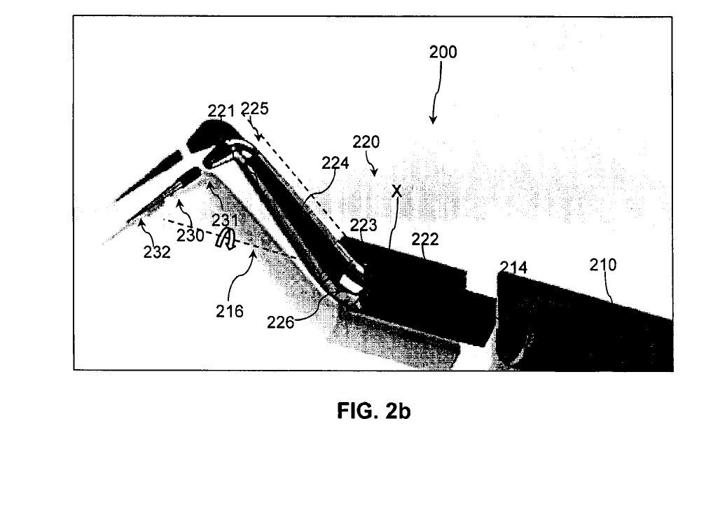

Now turning to FIGS. 1 and 2, the handle is an elongated piece with two magnetized hexagonal hollows 214, 215 at opposing ends of the handle piece along the axial (longitudinal) axis. The handle piece may be cylindrical or hexagonal. In some embodiments, the distance between any two parallel sides of magnetized hexagonal hollows may be between 0.5 and 1.5 cm. In one embodiment, the distance is 0.7 to 0.8 cm. In some embodiments, magnetized hexagonal hollows may be between 0.5 and 1.5 cm in depth. In one embodiment, the depth is 0.7 to 0.8 cm.

In one embodiment, handle piece 111 may be serrated for a firm, non-slip grip. In another embodiment, handle piece 112 may include a rubber, silicone or polymeric layer for a softer feel on the dental professional's hand. In some embodiments, handles 111, 112 each further include a middle portion 113 that may be smooth, non-serrated and uncovered by rubber, silicone or other polymeric materials for a different grip position wherein the handle is gripped between an index digit bent at the proximal inter-phalangeal joint and a thumb so that the axial axis of the handle is parallel to the middle and distal phalanx portions of the index digit.

FIGS. 2a and 2b illustrate an exemplary embodiment of curette head 230, arm 220 and handle 210 that may be assembled together to form curette 200. Handle 210 has a longitudinal axial axis 216 and arm 220 is co-axial with the handle. Arm 220 may be composed of three portions: main body portion 224, head end 221 and handle end 222 that are connected by connecting portions 225, 226. In one embodiment, head 230 may be a curette head. In another embodiment, head 230 may be an explorer, mirror, scalar, elevator, excavator, burnisher, plugger, spatula and carver in different configurations.

Connecting portion 225 is disposed between head end 221 and main body portion 224. In some embodiments, connecting portion 225 may be straight to provide a head angle, Y, of 90° between head 230 and the main body portion 224. In other embodiments, connecting portion 225 may be bent to provide a head angle Y that is anywhere within the range of 45-180°, preferably 45°, 75°, 90°, 120°, 135°, 150°, 165° or 180°.

Head end 221 is a magnetized hexagonal hollow for receiving head 230. In some embodiments, head end 221 may be between 0.5 and 1.5 cm in depth. In one embodiment, the depth is 0.7 to 0.8 cm. Head 230 further includes working tip 232 at one end and head hexagonal projection 231 at the opposing end. Working tip 232 comes in contact with teeth, gum, cheek, tongue, filling materials during a dental procedure. During assembly of the detachable components into a dental hand instrument, magnetized hexagonal projection 231 may be inserted into head end 221. The connection is internal and hidden as soon as the instrument is assembled. In some embodiments, head hexagonal projection 231 may be between 0.5 and 1.5 cm in length. In one embodiment, the length is preferably 0.7 to 0.8 cm.

Still referring to FIGS. 2a and 2b, connecting portion 226 is disposed between handle end 222 and main body portion 222. Handle 210 includes two magnetized hollow ends 214, 215 at opposing ends and middle portion 213. Handle end 222 is a magnetized hexagonal projection that may be inserted into magnetized hollow end 214 of handle 210 to form an internal connection that is hidden from view after the assembly of curette 200. In some embodiments, handle end 222 may be between 0.5 and 1.5 cm, preferably 0.7 to 0.8 cm. Handle angle X between main body portion 224 and axial axis 216 may be fixed at 180°. In other embodiments, handle angle X may be anywhere within the range of 90°-180°, preferably 90°, 120°, 135°, 150°, 165° and 180°.

In some embodiments, arm 220 further includes recess 223 that may be disposed between connecting portion 226 and handle end 222. Recess 223 may have a hexagonal cross section.

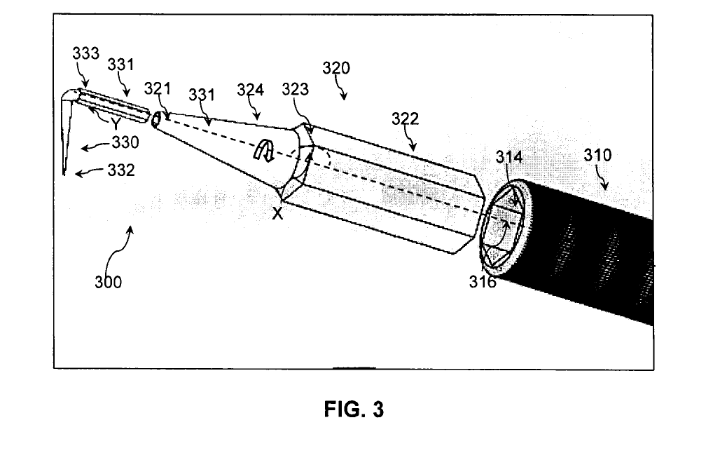

FIG. 3 provides another embodiment of a dental instrument assembly. Curette 300 may be composed of three detachable components: head 330, arm 320 and serrated handle 310. Arm 320 may include two portions: main body portion 324 and handle end 322. Handle end 322 is a magnetized hexagonal projection which may be inserted into magnetized hexagonal hollow 314 of handle 310 during assembly. Between handle end 322 and main body portion 324 is recess 323 which may have a hexagonal cross section. In one embodiment, the handle angle X between main body portion 324 axial axis 316 may be 180°. Main body portion 324 may assume the shape of a truncated cone wherein magnetized hexagonal hollow 321 may be disposed at the non-base end of the cone. In one embodiment, head 330 includes working tip 332, magnetized hexagonal projection 331a and these two portions may be joined by connecting portion 333. During assembly of curette 300, magnetized hexagonal hollow 321 receives head 330 through magnetized hexagonal projection 331. Magnetized hexagonal projection 331 may be 0.5 to 1.5 cm in length. In one embodiment, magnetized hexagonal projection 331 is 0.7-0.8 cm in length. In some embodiments, connecting portion 333 may be straight to provide a head angle, Y, of 180° between head 330 and the main body portion 324. In other embodiments, connecting portion 333 may be bent to provide a head angle Y that is anywhere within the range of 45°-180°, for example, 45°, 75°, 90°, 120°, 135°, 150° or 165°.

In the present disclosure, the combination of the hexagonal geometry and use of permanent magnet at arm-handle and arm-head connections provides greater endurance towards force and stress. The magnetized hexagonal feature prevents the arm part from being disconnected when applying rotational force at any direction. This is because the hexagonal geometry does not allow rotating. Moreover, the hexagonal hollows and projections are long enough to provide extra support and friction grip between pieces. In some embodiments, the hexagonal hollows and projections are 0.5-1.5 cm. In other embodiments, these hexagonal hollows and projections are 0.7-0.8 cm. The presence of permanent magnet at the arm-handle and arm-head connections enables a fast assembly of the detachable components and prevents disassembly during a dental procedure.

In addition, the hexagonal hollow and hexagonal projection of the arm component enables different combinations of the head angle and the handle angle for each type of dental instrument. This allows the dental professional to position the head at different angles on a third dimension, for example, perpendicular to the longitudinal axial axis of the instrument, or along on the same axial plane of the instrument. The flexibility helps the dental professional to reach areas in the mouth cavity that are extremely difficult to access, for example the distal surface of the third molar. This may not have been possible with dental instruments with only one flexible or adjustable connection.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A dental instrument, comprising:
an elongated handle having a hexagonal opening disposed at one end of the handle along a longitudinal axis of a main body of the handle, wherein the hexagonal opening is magnetized;
an arm including a main body portion, the arm including a magnetized hexagonal projection disposed at a first end of the arm, and a magnetized hexagonal opening disposed at a second end of the arm; and
a head including a main body of a working tip and a magnetized hexagonal projection extending from the working tip,
wherein the magnetized hexagonal projection of the head is configured to be inserted into the magnetized hexagonal opening of the arm, and the magnetized hexagonal projection of the arm is configured to be inserted into the magnetized hexagonal opening of the handle.

2. The dental instrument of claim 1, wherein each of the handle, the arm and the head are detachably assembled to each other at different angles with respect to each other.

3. The dental instrument of claim 2, wherein after each of the handle, the arm and the head are detachably assembled to each other, a longitudinal axis of the main body portion of the arm is oriented at an angle with respect to the longitudinal axis of the handle, and a longitudinal axis of the head is oriented at an angle with respect to the longitudinal axis of the main body of the arm.

4. The dental instrument of claim 3, wherein the angle between the longitudinal axis of the handle and the main body portion of the arm is 90°-180°.

5. The dental instrument of claim 3, wherein the angle between the head and the main body portion of the arm is 45°-180°.

6. The dental instrument of claim 1, wherein the magnetized hexagonal projections and magnetized hexagonal hollows are 0.5-1.5 cm.

7. The dental instrument of claim 1, wherein the arm further comprises a first connecting portion between the main body portion and the second magnetized hexagonal hollow and a second connecting portion between the main body portion and the second magnetized hexagonal projection.

8. The dental instrument of claim 1, wherein the head further comprises a third connecting portion.

9. The dental instrument of claim 1, wherein the handle further comprises a plurality of serrations on the outer surface.

10. The dental instrument of claim 1, wherein the handle further comprises a rubber, silicone or polymeric layer.

11. The dental instrument of claim 1, wherein the handle is a cylinder with a circular base.

12. The dental instrument of claim 1, wherein the handle is a prism with hexagonal base.

13. A kit, comprising:
a plurality of handles, each of the plurality of handles is an elongated, axial piece that includes a first magnetized hexagonal hollow disposed at one end of the piece along the axial axis;
a plurality of heads that each include a working tip and a first magnetized hexagonal projection; and
a plurality of arms that each include a main body portion, a second magnetized hexagonal projection disposed at a first end of the arm, and a second magnetized hexagonal hollow disposed at a second end of the arm,
wherein the first magnetized hexagonal projection of the head is inserted into the second magnetized hexagonal hollow of the arm and the second magnetized hexagonal projection of the arm is inserted into the first magnetized hexagonal hollow of the handle, and
wherein any one of the plurality of handles is configured to be engaged with any one of the plurality of arms, and any one of the plurality of arms is configured to be engaged with any one of the plurality of heads, such that a handle, an arm and a head arc detachably attached to each other.

14. The kit according to claim 13, wherein after each of the handle, the arm and the head are detachably assembled to each other, a longitudinal axis of the main body portion of the arm is oriented at an angle with respect to the longitudinal axis of the handle, and a longitudinal axis of the head is oriented at an angle with respect to the longitudinal axis of the main body of the arm.

15. The kit according to claim 14, wherein the handle, arm and head can be assembled at different angles and different combinations of angles for creating different dental instruments for different dental procedures.

16. The kit of claim 14, wherein the angle between the longitudinal axis of the handle and the main body portion of the arm is 90°-180°.

17. The kit of claim 14, wherein the angle between the head and the main body portion of the arm is 45°-180°.

18. The kit of claim 13, wherein the magnetized hexagonal projections and magnetized hexagonal hollows are 0.5-1.5 cm.

19. The kit of claim 13, wherein the arm further comprises a first connecting portion between the main body portion and the second magnetized hexagonal hollow and a second connecting portion between the main body portion and the second magnetized hexagonal projection.

20. The kit of claim 13, wherein the head further comprises a third connecting portion.

21. The kit of claim 13, wherein the handle further comprises a plurality of serrations on the outer surface.

22. The kit of claim 13, wherein the handle further comprises a rubber, silicone or polymeric layer.

23. The kit of claim 13, wherein the handle is a cylinder with a circular base.

24. The kit of claim 13, wherein the handle is a prism with hexagonal base.
